(19) United States
(12) Patent Application Publication
(10) Pub. No.: US 2011/0035683 A1
(43) Pub. Date: Feb. 10, 2011

(54) METHOD AND APPARATUS FOR SYNCHRONOUS, COLLABORATIVE MEDIA CONSUMPTION

(76) Inventors: Larry Stead, Upper Montclair, NJ (US); Alicia Abella, Morristown, NJ (US); Brian Amento, Morris Plains, NJ (US); Kermit Purdy, Bernardsville, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/537,763

(22) Filed: Aug. 7, 2009

(51) Int. Cl. G06F 3/00; G06F 15/16

(52) U.S. Cl. 715/753; 709/219; 709/204; 709/228

(57) ABSTRACT

In one embodiment, the present invention is a method and apparatus for synchronous, collaborative media consumption. In one embodiment, a method for providing media to a plurality of users includes delivering synchronously the media to a plurality of devices operated by the plurality of users via a communications channel and enabling a substantially real-time interaction among the plurality of users on the communications channel while delivering the media.

### FIELD OF THE INVENTION

The present invention relates generally to collaborative applications and relates more particularly to applications for allowing groups of users to collaboratively consume media.

Services that provide media (e.g., audio, video, text, images, etc.) over a network, such as Internet radio, have increased in popularity in recent years. However, these services typically provide media to users on an individual basis. That is, there is no means for the users to consume the media together (e.g., listen to the same Internet radio station at the same time) or to interact with each other in real time as they consume the media.

Moreover, most services of this nature allow users only limited control over the media that they consume. That is, although the users may be able to control the nature of the media that is provided (e.g. a genre of music), they typically cannot control the exact media that is provided (e.g., a specific song).

### SUMMARY OF THE INVENTION

In one embodiment, the present invention is a method and apparatus for synchronous, collaborative media consumption. In one embodiment, a method for providing media to a plurality of users includes delivering synchronously the media to a plurality of devices operated by the plurality of users via a communications channel and enabling a substantially real-time interaction among the plurality of users on the communications channel while delivering the media.

### BRIEF DESCRIPTION OF THE DRAWINGS

The teaching of the present invention can be readily understood by considering the following detailed description in conjunction with the accompanying drawings, in which:

FIG. 1 is a schematic diagram illustrating an exemplary system in which the embodiments of present invention may be implemented;

FIG. 2 illustrates an exemplary interface for providing an application for synchronous, collaborative media consumption, according to the present invention;

FIG. 3 is a flow diagram illustrating one embodiment of a method for providing synchronous, collaborative media consumption, according to the present invention; and

FIG. 4 is a high level block diagram of the media consumption method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for synchronous, collaborative media consumption. Embodiments of the invention provide a “channel” (e.g., a physical or virtual communications channel) on which a group of users can synchronously consume media that they select and interact with each other in substantially real time (i.e., accounting for normal delays associated with network conditions). Allowing the users to select and experience the media together and to simultaneously interact with each other enhances the social experience.

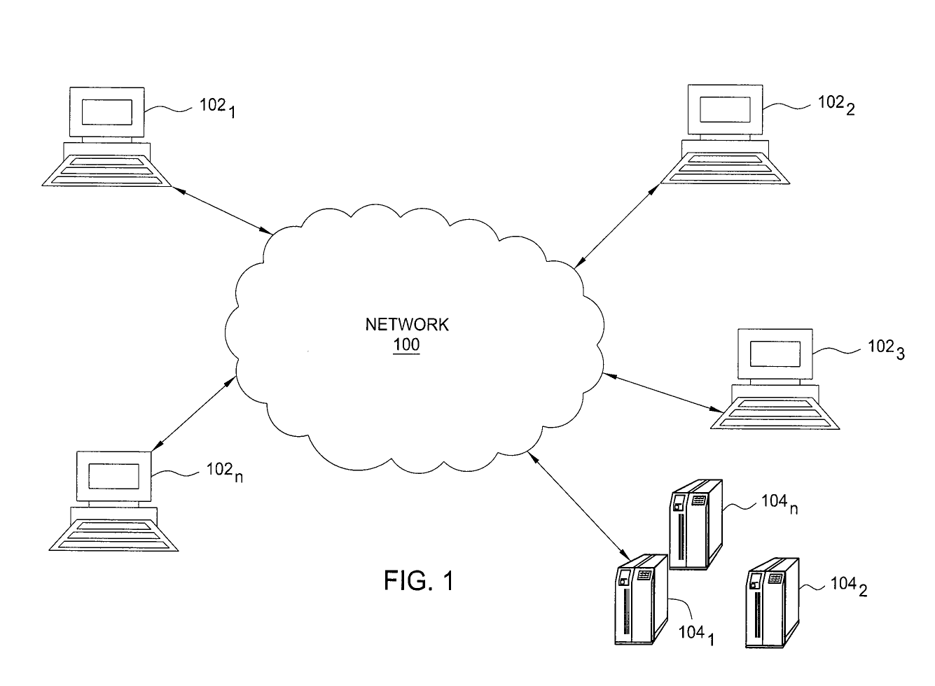

FIG. 1 is a schematic diagram illustrating an exemplary system in which the embodiments of present invention may be implemented. As illustrated, the system comprises a network 100 (e.g., a telephony network, a cellular network, a local area network, or the like), a plurality of user devices 102₁-102ₙ (hereinafter collectively referred to as “user devices 102”) connected to the network, and a plurality of servers 104₁-104ₙ (hereinafter collectively referred to as “servers 104”) connected to the network.

In one embodiment, an application for synchronous, collaborative media consumption is a web-based application that is hosted by at least one of the servers 104. User devices 102 access this application by connecting to the server 104 via the network 100. In another embodiment, the application for synchronous, collaborative media consumption is a stand-alone alone application that is installed on the user devices 102. In this case, user devices 102 interact with each other directly via the network 100 (e.g., in a peer-to-peer manner). In addition, the media provided by the application for synchronous, collaborative media consumption may be stored on the servers 104, on the devices operated by the users 102, or distributed over both the servers 104 and the user devices 102. The user devices 102 may use any one of a plurality of devices to access the application, including personal computers, laptop computers, tablet computers, cellular telephones, personal digital assistants, Internet Protocol (IP) televisions, gaming consoles, set top boxes, and the like.

In one embodiment, the application for providing synchronous, collaborative media consumption is a subscriber-based application in which user devices 102 can access dedicated “channels,” where the application may host any number of such channels. As described in further detail below, these channels provide a plurality of features that enable the users of the user devices 102 to synchronously share media and interact with each other while doing so.

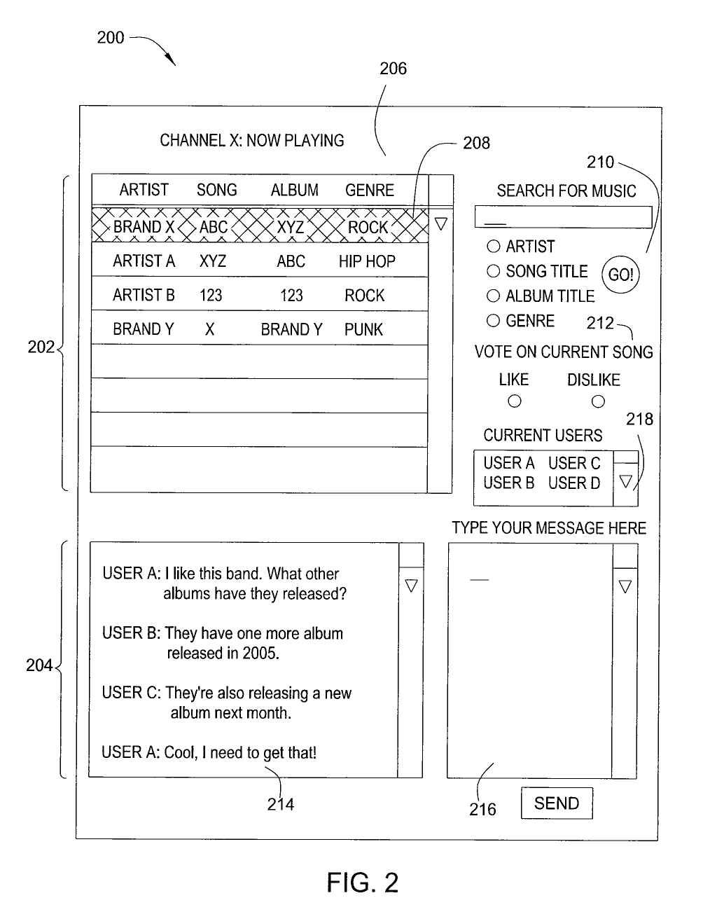

FIG. 2 illustrates an exemplary interface 200 for providing an application for synchronous, collaborative media consumption, according to the present invention. The interface 200 may be displayed, for example, on the user devices 102 of FIG. 1. Specifically, the interface 200 displays and receives data for an exemplary “channel” (i.e., Channel X) provided by the application.

As illustrated, the interface 200 comprises two main sections: a first section 202 in which media is provided and a second section 204 in which a substantially real-time “conversation” is provided.

The first section 202 comprises a plurality of features related to the queuing and delivery of the media, which may comprise any form of media (e.g., audio, video, text, images, or a combination thereof). For example, the media might primarily comprise music (e.g., songs), but provide accompanying images as a secondary media (e.g., album art). In the illustrated embodiment, Channel X provides media in the form of music (i.e., audio files). In one embodiment, the features comprising the first section 202 include one or more of the following: a list 206 of the media provided on the channel (e.g., the last N songs), the media 208 currently provided by the channel (e.g., song S playing now), a search interface 210 for assisting users in locating media to play on the channel (e.g., search by artist, song title, album title, or genre), and a voting mechanism 212 for allowing users to rate media provided by the channel (e.g., Vote on the current song: like or dislike).

The second section 204 comprises a plurality of features related to substantially real-time interactions between the users. For example, in one embodiment, the second section 204 provides a real-time chat feature that allows all of the users to converse with each other while consuming the provided media. In one embodiment, this chat features comprises one or more of the following: a chat window 214 in which the real-time conversation is displayed (e.g., in text form), a message window 216 through which a user can contribute comments to the real-time conversation, and a list 218 that displays the current users of the channel (e.g., the users who are currently “logged on” to the channel). Although the second section 204 is illustrated as providing a text-based chat feature, the present invention contemplates the use of other real-time interactions, such as video- and audio-based interactions.

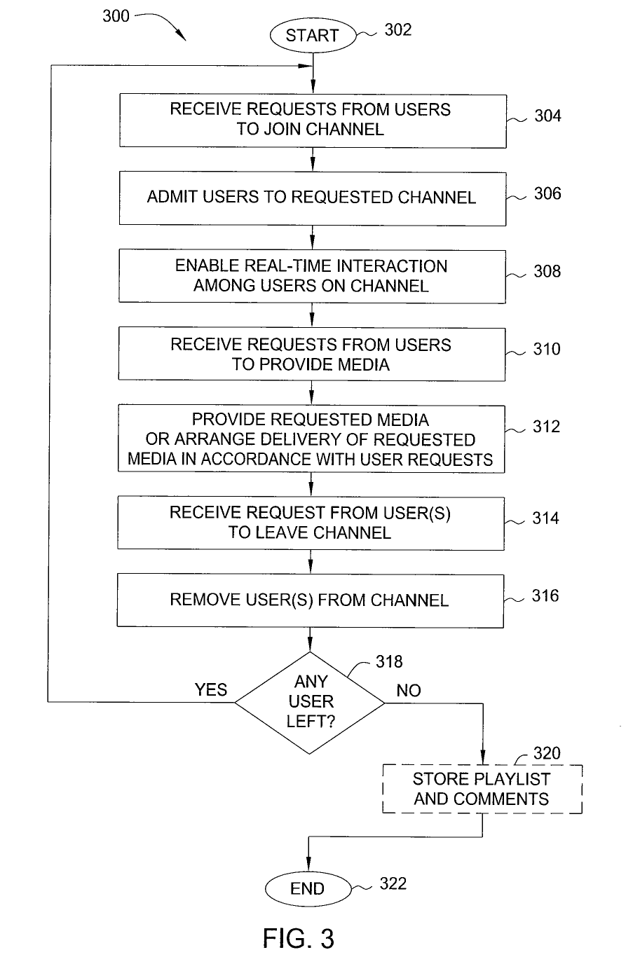

FIG. 3 is a flow diagram illustrating one embodiment of a method 300 for providing synchronous, collaborative media consumption, according to the present invention. The method 300 may be implemented, for example, at a user device or at a server that hosts an application for synchronous, collaborative media consumption, as discussed above. In particular, the method 300 illustrates an embodiment of a method for providing one “channel” for media consumption. In reality, an application in accordance with the present invention may simultaneously provide a plurality of such channels (where any number of these channels may operate in accordance with the method 300).

The method 300 is initialized at step 302 and proceeds to step 304, where the method 300 receives requests from two or more users to join a “channel” for synchronous, collaborative media consumption, as discussed above with respect to FIG. 2.

In step 306, the method 300 admits the users to the requested channel. In one embodiment, admission to the requested channel is conditioned upon authentication of the users and/or the user devices used by the users, for example by examining usernames and/or passwords provided by the users in order to verify that the users are authorized to access the requested channel.

In one embodiment, the requested channel is created in an ad-hoc manner. That is, the requested channel is newly created upon the request of the users. In another embodiment, the method 300 maintains persistent channels. That is, records for the requested channel are stored, so that the users can re-join a channel that they previously shared.

Once the users have been admitted to the requested channel, the method 300 proceeds to step 308 and enables real-time interaction among the users. In one embodiment, the method 300 launches a real-time chat feature that allows all of the users currently admitted to the channel to converse with each other (e.g., by text, audio, video, or the like). In one embodiment, enablement of the real-time chat feature involves receiving messages from individual users and displaying (or playing, in the case of an audio- or video-based chat feature) the messages for other users to see. Thus, the messages may serve as an annotation to the media that is simultaneously provided, as described below.

In step 310, the method 300 receives requests from the users to provide media. For example, if the media provided by the requested channel comprises music, the method 300 may receive requests to play particular songs or artists. In one embodiment, the user requests may comprise not the media itself, but the order in which the media is to be provided (e.g., re-ordering a “playlist” of songs). In another embodiment, a user request may comprise a rejection of previously requested media (e.g., a request to not play a song requested by another user). In another embodiment, the user requests may comprise user feedback in the form of “votes” on previously consumed media (e.g., “I liked/did not like Song X”).

In step 312, the method 300 provides the media, in accordance with the user requests. Thus, in the example above, the method 300 plays or arranges to have played the requested songs in the requested order, and may omit any rejected songs.

In step 314, the method 300 receives a request from at least one of the users to leave (e.g., log off) the channel. Thus, in step 316, the method 300 removes those users wishing to leave from the channel. For instance, the method 300 may log the users out of the channel.

In step 318, the method 300 determines whether there are any users still participating on the channel. If the method 300 concludes in step 318 that there are still users participating on the channel, the method 300 returns to step 304 and continues to admit users to the channel, to enable real time interaction among the users, and to provide requested media to the users, as discussed above.

Alternatively, if the method 300 concludes in step 318 that there are no users still participating on the channel, the method 300 proceeds to optional step 320 (illustrated in phantom) and stores the playlist of media that was provided on the channel during the current session, as well as, in one embodiment, the user comments received via the real-time interaction. Storage of this information allows the method 300 to provide persistent sessions in which users may return to the channel at a later time and resume their activities from where they left off. The method 300 then terminates in step 322.

The present invention therefore allows a plurality of users to synchronously consume media on a common “channel”, where the selection of media is entirely or at least partly user-driven. The invention also allows the users to interact in substantially real time as they consume the media, thereby enhancing the social experience of the act of media consumption. This experience, in turn, potentially allows the users to learn more about each other and about new media.

In one embodiment, the present invention allows users different levels of access to the channels via which the media is consumed. The levels of access may be based on subscription fees that the users pay to a service hosting the channels or on a level of user participating (e.g., whether or not the users have registered with such a service, or the seniority of the users relative to the channels). For example, a particular user may be permitted to consume media on a particular channel, but may not be allowed to interact with the channel's other users unless he pays a subscription fee, registers with the service, has been a user of the channel for a minimum period of time, or has received a minimum level of feedback from the other users. In another example, the user may be allowed to consume media and to interact with the other users, but may not be permitted to select or control media for consumption until such criteria are met.

In another embodiment, the present invention may enable “private” channels where membership is restricted to certain users. Alternatively, the present invention may provide “public” channels having open membership.

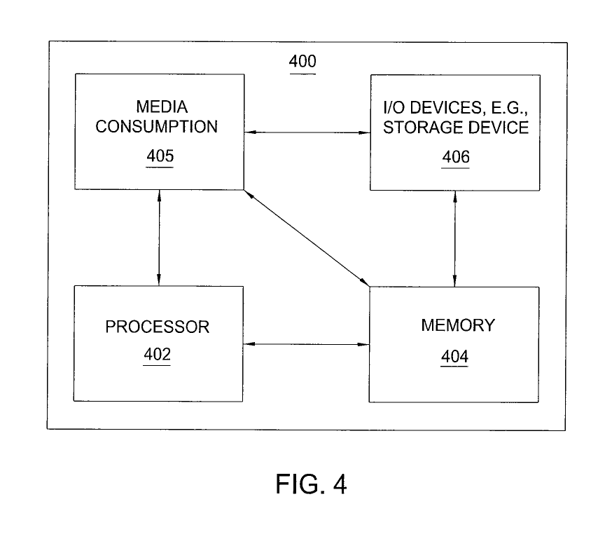

FIG. 4 is a high level block diagram of the media consumption method that is implemented using a general purpose computing device 400. In one embodiment, a general purpose computing device 400 comprises a processor 402, a memory 404, a media consumption module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the media consumption module 405 can be implemented as a physical device or subsystem that is coupled to a processor through a communication channel.

Alternatively, the media consumption module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the media consumption module 405 for synchronous, collaborative media consumption described herein with reference to the preceding Figures can be stored on a computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing media to a plurality of users, the method comprising:
delivering synchronously the media to a plurality of devices operated by the plurality of users via a communications channel; and
enabling a substantially real-time interaction among the plurality of users on the communications channel while delivering said media.

2. The method of claim 1, wherein the media is provided in accordance with at least one item of feedback received from at least one of the plurality of users.

3. The method of claim 2, wherein the at least one item of feedback comprises a request to provide at least one specific item of media.

4. The method of claim 2, wherein the at least one item of feedback comprises at least one request to provide individual items of the media in a specific order.

5. The method of claim 2, wherein the at least one item of feedback comprises a request to not provide a specific item of media.

6. The method of claim 2, wherein the at least one item of feedback comprises a vote related to a previously consumed item of the media.

7. The method of claim 1, wherein the communications channel is created on an ad-hoc basis.

8. The method of claim 1, wherein the communications channel is created on a persistent basis.

9. The method of claim 1, further comprising:
storing at least one of: a list of the media or a record of the substantially real-time interaction.

10. The method of claim 1, wherein a level of access to the media and to the substantially real-time interaction is based on a payment of a subscription fee.

11. The method of claim 1, wherein a level of access to the media and to the substantially real-time interaction is based on a level of user participation on the communications channel.

12. The method of claim 1, wherein a membership of the communications channel is restricted.

13. The method of claim 1, wherein the media is at least one of: audio, video, image, or text.

14. The method of claim 1, wherein the method is implemented as a web-based application.

15. The method of claim 1, wherein the method is implemented as a stand-alone application.

16. The method of claim 1, wherein the media is distributed across at least one of: one or more of the plurality of devices or at least one server coupled to the communications channel.

17. A computer readable storage medium containing an executable program for providing media to a plurality of users, where the program performs the steps of:
delivering synchronously the media to a plurality of devices operated by the plurality of users via a communications channel; and
enabling a substantially real-time interaction among the plurality of users on the communications channel while delivering said media.

18. The computer readable storage medium of claim 17, wherein the media is provided in accordance with at least one item of feedback received from at least one of the plurality of users.

19. The computer readable storage medium of claim 17, further comprising:
storing at least one of: a list of the media or a record of the substantially real-time interaction.

20. A system for providing media to a plurality of users, comprising:
a server; and
a network for communicatively coupling the server to a plurality of devices operated by the plurality of users,
where the server hosts an application that:
delivers synchronously the media to the plurality of devices via a communications channel; and
enabling a substantially real-time interaction among the plurality of users on the communications channel while delivering said media.
